(19) United States
(12) Patent Application Publication
(10) Pub. No.: US 2008/0303646 A1
(43) Pub. Date: Dec. 11, 2008

(54) Tactile Feedback Device for Use with a Force-Based Input Device

(76) Inventors: James K. Elwell, Salt Lake City, UT (US); David A. Soss, Salt Lake City, UT (US); Robert Mullins, Centerville, UT (US); Peter S. Shay, Bountiful, UT (US)

Correspondence Address: THORPE NORTH & WESTERN, LLP., P.O. Box 1219, SANDY, UT, 84091-1219, US

(21) Appl. No.: 12/125,901

(22) Filed: May 22, 2008

Related U.S. Application Data
(60) Provisional application No. 60/931,399, filed on May 22, 2007.

(51) Int. Cl. G08B 6/00

(52) U.S. Cl. 340/407.2

(57) ABSTRACT

A tactile device comprising a tactile device and a feedback mechanism operable with a sensing surface to receive a force input from a user and transfer that force input to a force sensing element. The tactile device is configured to allow the user to touch the tactile device and register an input force with the force sensing element. The tactile device is also operable with the feedback mechanism to provide feedback to the user that the force input from the user has been registered with the force sensing element.

### RELATED APPLICATIONS

This application claims the benefit of U.S. Provisional Application Ser. No. 60/931,399, filed May 22, 2007, and entitled, “Tactile Feedback Device for Use With a Force-Based Input Device,” which is incorporated by reference herein in its entirety.

### FIELD OF THE INVENTION

The present invention relates generally to input devices or touch screens, and more specifically to a tactile feedback device operable with the input device to provide tactile feedback to a user upon applying a force thereto for activation of the input device.

### BACKGROUND OF THE INVENTION AND RELATED ART

Input device, otherwise known as touch screens, are becoming increasingly common because of the ease in which they display information and allow users to interface with various software programs. Input devices also provide users with a level of convenience by reducing the need for additional external hardware common with traditional computer systems. A touch screen works by displaying information on a screen and allowing a user to directly interface with a software program by touching certain portions of the screen with a finger or some other object, such as a stylus. Thus, input devices eliminate the need for external hardware devices, such as a keyboard or mouse, by simultaneously displaying information and transmitting input signals to and from a software program on a single piece of hardware. For example, input devices can be programmed to display a typical keyboard and, when touched, to input the corresponding signal for each key, thus allowing a user to type a document by simply touching the corresponding keys on the screen. Furthermore, input devices can be programmed to navigate a user through various commands and functions and can be designed to aid a user in reaching an objective. For example, Automatic Teller Machines (ATMs) are programmed to navigate a user through various commands and screens depending on whether the user would like to deposit or withdraw money and depending on which account the user would like to access.

One problem with input devices, however, is their two dimensional limitation. Typical keyboard and mice configuration comprise a three-dimensional design that provides the user with a tactile sensation as they use the hardware. For example, a typical keyboard is comprised of three-dimensional keys that can be configured to produce an audible clicking noise when depressed or even in the absence of a clicking noise, the depression of the key provides the user with a sense of displacement. Likewise, a mouse is typically configured to produce an audible clicking noise when its buttons are depressed and likewise provides the user with a sense of displacement. Thus, when using this hardware, a user is aware that an input signal has been transmitted to the computer. Unlike this hardware, input devices are flat and do not provide a user with a tactile sensation when a corresponding key on the touch screen has been selected. Users are typically aware that an input signal has been received when the touch screen displays a new screen or a corresponding symbol or object appears on the screen. Since input devices are becoming increasingly more common, it would be advantageous if a user could benefit from the ease of touch screen technology, while retaining the tactile feedback provided by typical external hardware.

### SUMMARY OF THE INVENTION

In light of the problems and deficiencies inherent in the prior art, the present invention seeks to overcome these by providing a tactile feedback device for use with a force-based input device to register a force on a force-sensing element as applied to the tactile feedback device and transferred to the force-sensing element. The tactile feedback device comprises a mechanical assembly used to provide tactile feedback to a user.

In accordance with the invention as embodied and broadly described herein, the present invention resides in a tactile feedback device operable with a force-based input device comprising a receiving component to receive a force input from a user that is operable to displace and transfer the received force to a sensing surface of the force-based input device and a feedback mechanism to provide tactile feedback to the user to ensure proper and complete force transfer and registration.

The present invention also resides in an input system comprising a touch-based input device comprising a sensing element having a sensing surface, wherein the sensing element is configured to receive and register a force input from a user, and to output a signal to determine the location of the applied force and a tactile feedback device comprising a receiving component and a feedback mechanism, the tactile feedback device operates to provide the force input and tactile feedback to the user.

The present invention further resides in a method for receiving tactile feedback from a tactile feedback device comprising providing a tactile feedback device operable with a force-based input device comprising a receiving component to receive a force input from a user that is operable to displace and transfer the received force to a sensing surface of the force-based input device, and a feedback mechanism to provide tactile feedback to the user to ensure proper and complete force transfer and registration, applying a force to the receiving component, and receiving tactile feedback from the feedback mechanism.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a top view of a force sensing element comprising a force-sensing element having a sensing surface, and a tactile device, wherein a force is registered on the force-sensing element upon a force being applied to the tactile device, and wherein the tactile device returns feedback to the user to signify a proper and complete registration of force;

FIG. 2 illustrates a block diagram of a tactile device according one exemplary embodiment of present invention, wherein the tactile device comprises a feedback mechanism that is operable with a sensing surface of a force-sensing element to register an input by a user;

FIG. 3 illustrates an exploded perspective view of an exemplary feedback mechanism in the form of a feedback spring operable with a multiple component tactile device comprising a head component and a base component;

FIG. 4 illustrates a top view of the tactile device of FIG. 3;

FIG. 5 illustrates a sectional view of the tactile device of FIG. 3, taken along the line A-A;

FIG. 6 illustrates a top view of another exemplary embodiment of a tactile device similar to that of FIG. 3, wherein the tactile device comprises a smaller base component and the feedback spring is made to rest directly on the force-sensing surface;

FIG. 7 illustrates a sectional view of the tactile device of FIG. 6, taken along the line B-B;

FIG. 8 illustrates a bottom view of another exemplary embodiment of a tactile device comprising a single component configuration operable with a feedback mechanism, wherein the tactile device is configured to attach to a sensing surface via an adhesive material;

FIG. 9 illustrates a sectional view of the tactile device of FIG. 8, taken along the line C-C;

FIG. 10 illustrates a bottom view of another exemplary embodiment of a tactile device similar to the tactile device of FIG. 8, wherein the tactile device is configured to attach to the sensing surface via a screw or bolt; and

FIG. 11 illustrates a side view of the tactile device of FIG. 10.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a tactile feedback device operable for use with a force-based input device, such as those described in U.S. application Ser. No. 11/402,694, filed Apr. 11, 2006, and entitled, “Force-based Input Device;” U.S. Application No. 60/834,663, filed Jul. 31, 2006, and entitled, “Projected Force-Based Input Device;” and U.S. application Ser. No. 12/002,334, filed Dec. 14, 2007, and entitled, “Force-Based Input Device Having a Modular Sensing Component,” each of which are incorporated by reference in their entirety herein, wherein the tactile feedback device comprises a receiving component and a feedback mechanism, that is operable with a sensing surface of a force-sensing element of a force-based input device to receive a force input from a user, to displace and transfer the received force to the force-sensing element, and to provide tactile feedback to the user to ensure proper and complete force transfer and registration. More specifically, the tactile device is configured to be operable with and supported about the sensing surface of a force-based input device to allow the user to apply a force to the tactile device to register an input force with the force-sensing element. The tactile device also operates to provide feedback to the user that the force input has been registered with the force sensing element. The tactile device and the feedback mechanism may be configured as a single component, or an assembly of several components.

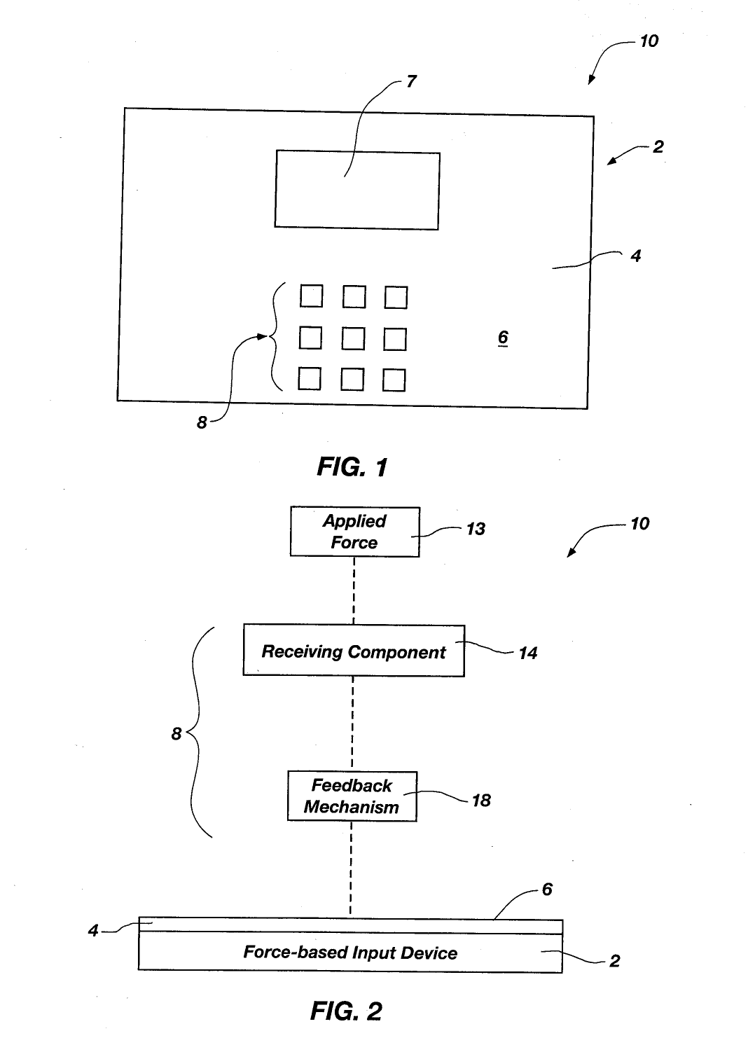

With reference to FIG. 1, illustrated is an input system 10 comprising a force-based input device 2 comprising a force-sensing element 4 having a sensing surface 6, and a plurality of tactile feedback devices 8, wherein the force-sensing element 4 is designed and configured to receive and register a force input from a user via one of the tactile devices 8, and to output signal data or other information to determine the location of the applied force about the tactile device 8. The force-based input device is also shown as comprising a screen 7 that can be used to visually illustrate a result of the applied force about the tactile feedback devices 8.

The tactile devices 8 are configured to sense an applied force from the user and transfer the force to the force-sensing element 4, preferably only providing tactile user feedback in the event a proper force transfer is made. The tactile device 8 may comprise a receiving component that receives the applied force, and that facilitates touch from a user to effectuate the transfer and registration of the applied force about the force-sensing element 4. The tactile device 8 may comprise a key, push button, or any other structural configuration where a user pushes a surface to cause the tactile device to register a force on the force-sensing element 4 and provide the user tactile feedback. The force-sensing element 4 may be designed to measure the strain in the force-based input device in response to an applied force, and to output various signals to one or more signal processors, which signals may correspond to the applied force received from the tactile device 8, as activated by the user. A signal processor may be used to determine a location and/or a magnitude of a force input about a sensing element 4.

FIG. 2 further illustrates a block diagram of the force-based input device of FIG. 1, wherein the force-based input device comprises a tactile device 8 operable with a force-sensing element 4 having a sensing surface 6. FIG. 2 further illustrates the receiving component 14 and the feedback mechanism 18 of the tactile device 8, and the applied force 3 from a user on the receiving component 14 of the tactile device 8. The receiving component 14 is configured to contact and be supported about the sensing surface 6 and to allow the user to apply a force 3 to the receiving component 14 for the purpose of transferring and registering a force about the force-sensing element 4 (see FIG. 1). The receiving component 14 is also operable with the feedback mechanism 18 to contain or otherwise house and operably support the feedback mechanism 18. The feedback mechanism 18 functions provide positive tactile feedback to the user that the force received has been transferred and registered with the force-sensing element 4. In one aspect, the receiving component 14 may be independent of the feedback mechanism 18, and configured to support the feedback mechanism 18 as an assembled component. In another aspect, the receiving component 14 and the feedback mechanism 18 may be integrally formed with one another. The receiving component 14 may further be configured to comprise a single component or multiple components that work together upon assembly.

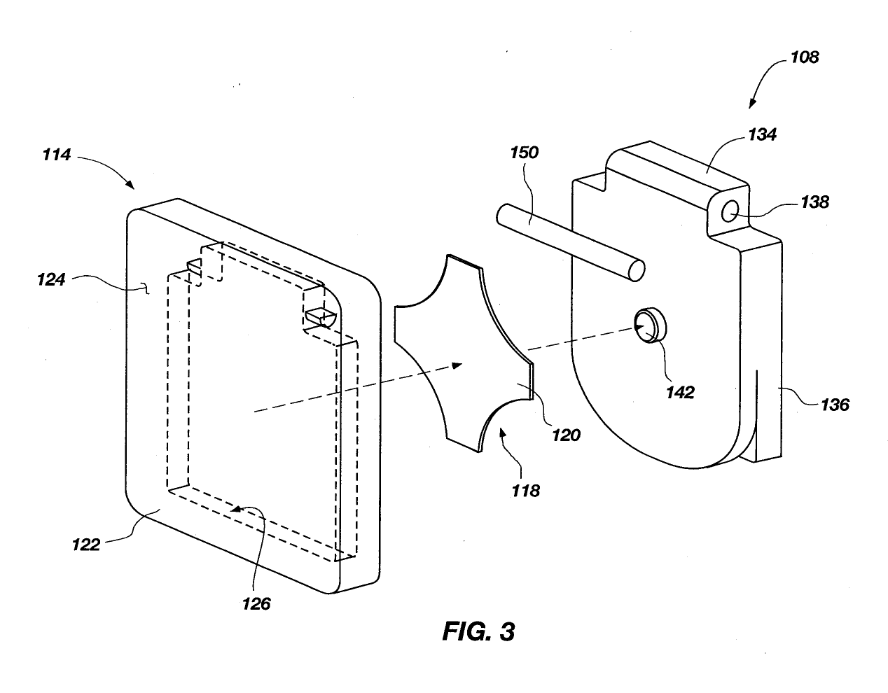

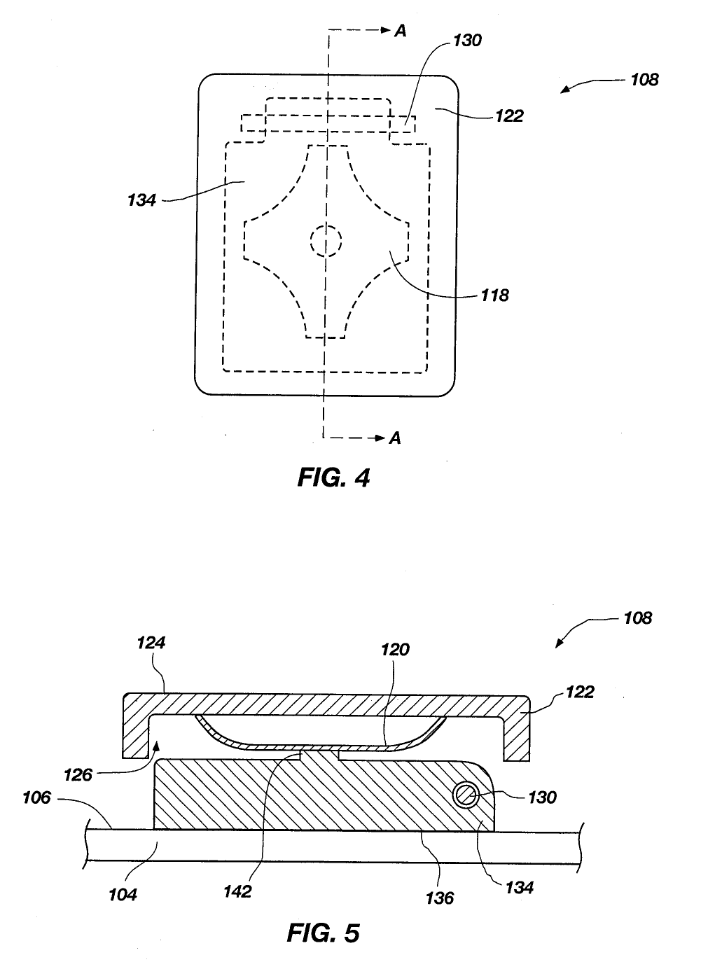

The tactile feedback device of the present invention may comprise many different types and configurations. Referring now to FIGS. 3, 4, and 5, illustrated is a tactile feedback device in accordance with one exemplary embodiment of the present invention. For example, a receiving component 114 may be configured as a pivoting member to pivot in response to an input force. Specifically, the tactile feedback device 108 comprises a receiving component 114 and a feedback mechanism 118 in the form of a spring 120, wherein the receiving component 114 comprises multiple components including a head component 122 and a base component 134. The head component 122 includes a top surface 124 where the user inputs a force such as by touching the top surface 124 of the head component. The head component 122 further includes a recessed area 126 on the surface opposite the top surface 124 that is configured in a manner to allow the base component 134 to nest within the recessed area 126, and that is configured to couple a pin 130 within the recessed area, wherein the pin 130 can pivotally couple the head component 122 to the base component 134 to enable the head component 122 to move relative to the base component 134. The recessed area 126 is also configured to receive the spring 120 between the base component 134 and the head component 122 to provide tactile feedback.

The base component 134 is configured to be substantially the same shape as the recessed area 126, but is sized smaller than the recessed area 126 to permit the base component 134 to nest within the recessed area 126. The base component 134 includes a bottom surface 136 that can be attached to the sensing surface 106 of the force-sensing element 104 via adhesives, bolts, welds, or any method known to one skilled in the art, and that can sufficiently transmit a threshold force as applied to the head component 122. The surface opposite the bottom surface includes a post 142 centered about the surface that is designed and configured to allow the center of the spring 120 to rest on the surface of the post 142 in an elevated position above the surface of the base component 134. The base component further includes an aperture 138 configured in a manner to receive the pin 130 and to allow the head component 122 to pivot around the aperture 138 and pivot with respect to the base component 134.

The feedback mechanism, shown as spring 120, may comprise different configurations and spring constants. In the exemplary embodiment shown, the spring 120 comprises a circular member having a domed configuration or geometry, wherein the edges of the spring are raised above the center of the spring in a manner to permit the underside of the spring to rest on the post 142 of the base component 134 with the edges of the spring resting on the surface of the recessed area 126. As so related, the spring, in a resting state, creates a gap between the surface of the recessed area 126 and the surface of the base component 134.

An appropriate spring 120 may be constructed or selected so that the spring produces a tactile sensation when compressed that can be transferred to the head component, and subsequently to the user in a timely manner and prior to the user removing his or her hand or object from the tactile device. This tactile feedback sensation preferably occurs only after a proper force transfer is made from the head component 122 to the base component 134, and subsequently to the sensing surface 106 of the force-sensing element 104, and after such force has been registered by the force-sensing element 104. The tactile sensation may be audible or physical or both. For example, the tactile feedback device may provide a snap action or small vibrations transferred through the head component 122 when compressed and felt by the user. In this manner, a user may transmit a force to the sensing surface 104, and thus to the force sensing element, and receive feedback by touching the head component 122 in a manner to compress the feedback spring 120, wherein the force is transferred to the sensing surface 104 and force sensing element via the base component 134 and the tactile sensation is transferred to the user via the head component 122. An example of a spring 120 may be a snap dome.

Alternatively, the tactile feedback device may provide an audible clicking or other sound. Other tactile feedback sensations will be obvious to those skilled in the art.

In another exemplary embodiment, the feedback mechanism 118 may comprise an electronic switch (not shown) mounted between the head component 122 and the base component 134. The electronic switch could be configured to provide a tactile sensation, such as vibrations via a vibrating element contained within the tactile device, when an electrode (not shown) on the underside surface of the head component 122 contacts an electrode (not shown) on the surface of the base component 134, and when the force input by the user is transferred to and registered by the force-sensing element. In any case, one skilled in the art will recognize that other types of feedback mechanisms are possible. Therefore, the description of the recited embodiments is not meant to be limiting in any way.

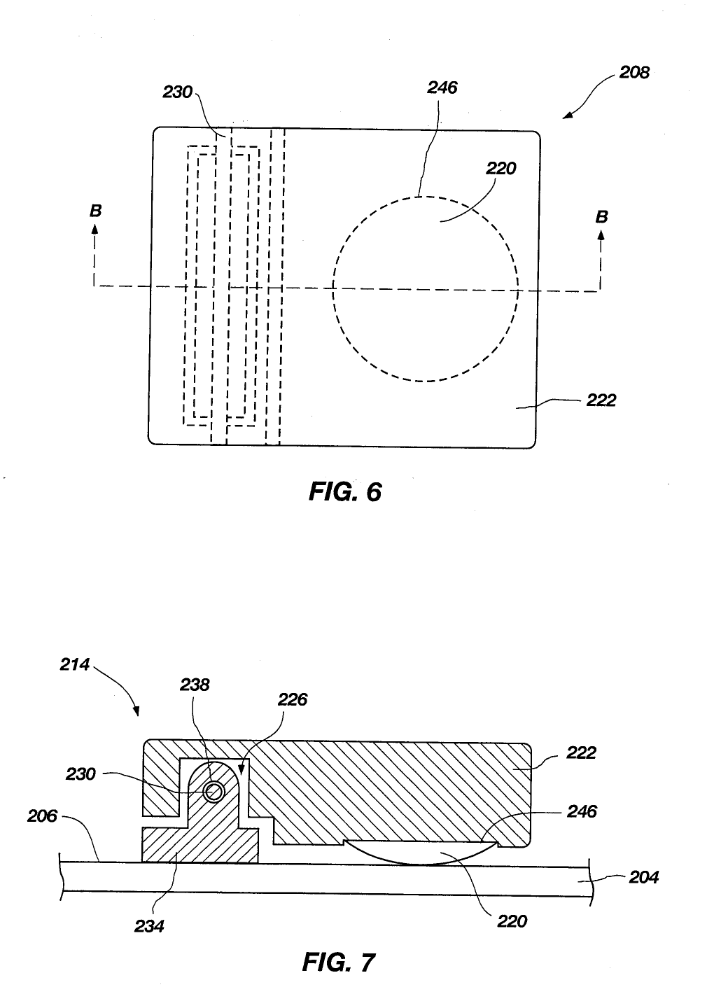

FIGS. 6 and 7 illustrate a tactile device in accordance with another exemplary embodiment of the present invention. In this particular embodiment, the tactile device 208 comprises a receiving component 214 and a feedback mechanism in the form of a spring 220 that is supported about a lower surface of the receiving component 214, and that rests directly on the sensing surface 206 of the force-sensing element 204. In this embodiment, the head component 222 is configured to pivotally couple with the base component 234 via a pin 230 in an aperture 238 within a recessed area 226 of the head component 222. The head component 222 is also configured to directly receive an applied force. However, unlike the tactile feedback device 108 described above, wherein the force is transferred from the feedback mechanism in the form of a spring 120 to the base component 134 and subsequently to the sensing surface 106, the tactile feedback device 208 causes the force to be transferred to the sensing surface 206 directly from the feedback spring 220 as the feedback spring 220 is configured to rest directly on the sensing surface 206. Further, as mentioned in the description above, the feedback spring 220 acts to produce a tactile sensation that is transferred to the user via the head component 222. The head component 222 may further include an additional recessed area 246 that is configured to receive and maintain the feedback mechanism in the form of a spring 220 in a position relative to the sensing surface 206 and head component 222.

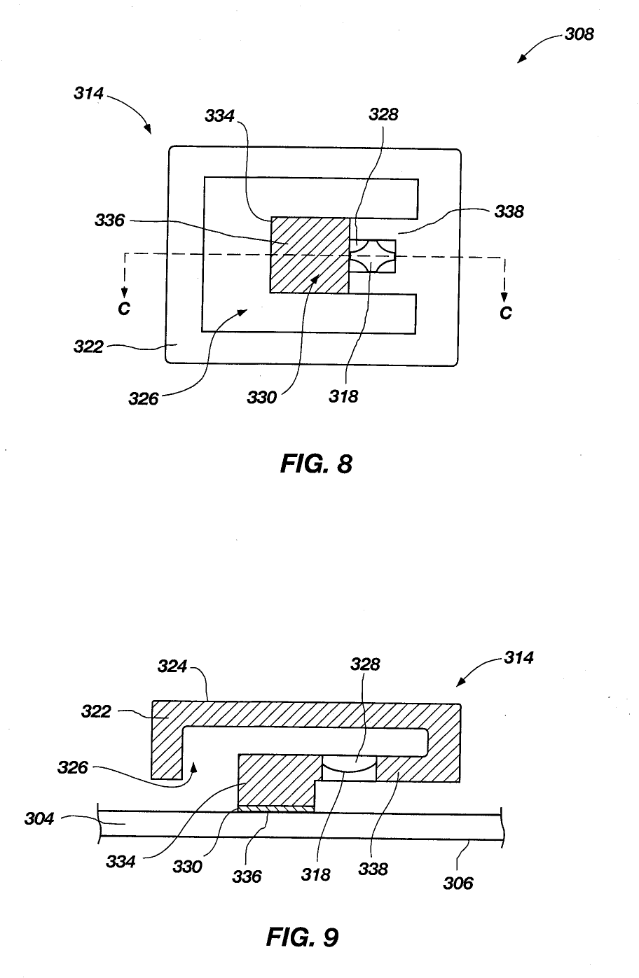

Referring now to FIGS. 8 and 9, illustrated is a tactile feedback device in accordance with still another exemplary embodiment of the present invention. In this particular embodiment, the tactile device 308 comprises a receiving component 314 and a feedback mechanism 318, wherein the receiving component 314 is coupled to the feedback mechanism 318, and wherein the receiving component 314 comprises a single compliant member having a head component 322 integrally formed with a base component 334, and further wherein the compliant member facilitates flexing of the receiving component 314. A receiving component 314 configured as a compliant member may bend in response to an input force. The head component 322 includes a top surface 324 where the user inputs a force such as by touching the top surface 324 of the head 322. The head component 322 further includes a hollow area 326 on the surface opposite the top surface 324 that is configured to allow the receiving component 314 to flex, and the base component 334 to penetrate the hollow area 326 when a force is applied and the receiving component 314 flexes. The base component 334 may be inseparably coupled to the head component 322 through a neck 338 that flexes in response to a force input. A neck 338 may also extend from the head 322 into the hollow area 326 and center the base component 334 in relation to the head component 322 and position the base component 334 slightly above the hollow area 326. The neck 338 may further include an aperture 328 configured and designed to support the feedback mechanism 318 and to facilitate the operation of the feedback mechanism 318 when a force is applied to the head 322. Further, the receiving component 314 may be made of a flexible material that allows the receiving component 314 to flex when a user applies a force and to return to a pre-flexed condition upon removal of the applied force. More specifically, the neck 338 can be made of flexible material that flexes as a force is applied and that allows the base component 334 to penetrate the hollow area 326. A single component tactile device can be constructed via molding, machining, or any other method known to one skilled in the art.

The base component 334 of the receiving component 314 may be sized smaller than the hollow area 326 to allow the base component to easily penetrate the hollow area 326 when a force is inputted to the head 322. The base component 334 includes a bottom surface 336 that may be configured to attach or relate to the sensing surface 306 of the force-sensing element 304 and that locates the tactile device 308 above the sensing surface 306. In one embodiment, the base component 334 may be attached to the sensing surface 306 via adhesive material 330. The adhesive material 330 may be applied to a substantially flat bottom surface 336 of the base component 334, and the receiving component 314 may be bonded to the sensing surface 306 by placing the bottom surface 336 and adhesive material 330 on the sensing surface 306.

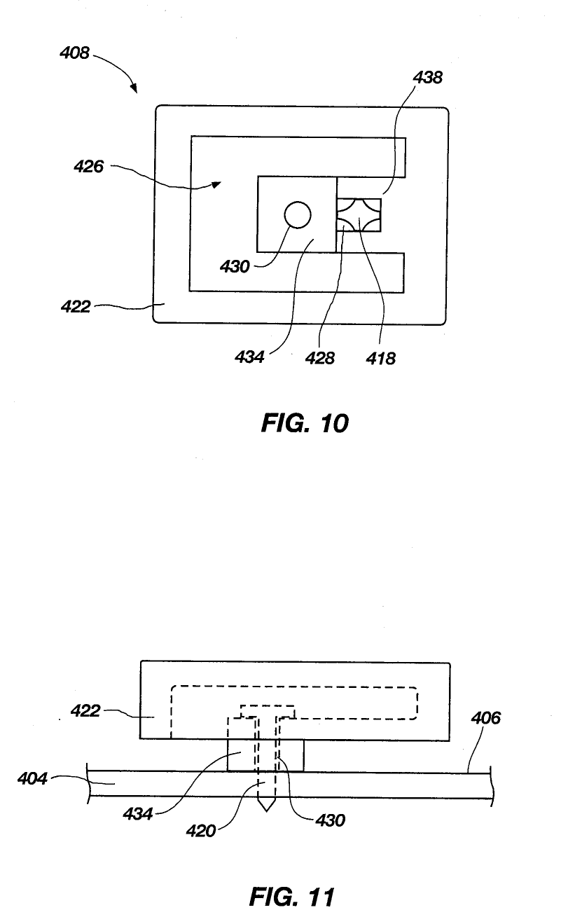

FIGS. 10 and 11 illustrate a tactile feedback device in accordance with still another exemplary embodiment of the present invention. In this particular embodiment, the tactile feedback device 408 is similar in form and function as the tactile feedback device 308 of FIGS. 8 and 9. However, in this embodiment, the tactile feedback device 408 comprises means for attaching or securing the base component 434 to the sensing surface 406 of force-sensing element 404 in the form of a screw or bolt. The base component 434 may include an aperture 430 extending through the base 434 and configured to allow a screw or bolt 420 to pass through the base 434 and attach to the sensing surface 406. In this manner, the base 434 may be attached or secured to the sensing surface 406 by placing the screw or bolt 420 through the aperture 430 and either driving the screw 420 into the force-sensing element 404 or placing the bolt 420 through a preexisting hole in the sensing surface (not shown) and securing the bolt with a securing member such as a nut (not shown). Obviously other arrangements could be used to attach or secure the base and tactile device to the sensing surface, as will be recognized by those skilled in the art.

Referring to FIGS. 8-11, and tactile feedback devices 308 and 408, in one embodiment the neck 338/438 may include an aperture 328/428 configured to couple the feedback mechanism 318/418. The feedback mechanism may be configured or selected as a separate component substantially the same size as the aperture and configured to produce a tactile sensation when the receiving component 324/424 and more specifically the neck flexes. The tactile sensation may be produced via a spring (not shown) having a snap action or vibration when it is flexed, or an electronic device (not shown) similar to the one discussed above, wherein the tactile sensation is produced when opposing electrodes contact each other as the neck flexes, or by any method known to one skilled in the art, the present description not limiting the invention in any way. The separate component feedback mechanism may be inserted into and coupled to the aperture in a manner to permit the tactile sensation to reach the head component 322/422 and subsequently the user. A tactile sensation can reach the head component 322/422 by traveling through the neck 338/438 or by disturbing the air in the hollow area or by any other method known to one skilled in the art.

In another embodiment, the receiving component may be configured to include the feedback mechanism as an additional feature of the single structure receiving component (not shown). For example, the single structure receiving component can be constructed with opposing rigid elements (not shown) in the aperture that brush past each other as the neck flexes in a manner to produce a tactile sensation. As discussed previously, the single component tactile device with the feedback mechanism as an additional feature may be constructed via molding, machining, or any other method known to one skilled in the art.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A tactile feedback device operable with a force-based input device comprising:
a receiving component to receive a force input from a user that is operable to displace and transfer the received force to a sensing surface of said force-based input device; and
a feedback mechanism to provide tactile feedback to the user to ensure proper and complete force transfer and registration.

2. The tactile feedback device of claim 1, wherein the receiving component is configured to contact and be supported about the sensing surface.

3. The tactile feedback device of claim 1, wherein the feedback mechanism is a spring.

4. The tactile feedback device of claim 1, wherein the receiving component comprises a head component and a base component.

5. The tactile feedback device of claim 4, wherein the head component comprises a top surface where the user inputs a force and a recessed area on a surface opposite the top surface that is configured to allow the base component to nest within the recessed area, and that is configured to couple a pin within the recessed area, wherein the pin pivotally couples the head component to the base component to enable the head component to move relative to the base component, wherein the recessed area is configured to receive the spring between the base component and the head component to provide the tactile feedback.

6. The tactile feedback device of claim 4, wherein the feedback mechanism is supported about a lower surface of the receiving component and rests directly on the sensing surface causing the force to be transferred to the sensing surface directly from the feedback mechanism, and further wherein the head component is configured to pivotally couple with the base component and to directly receive the applied force.

7. The tactile feedback device of claim 6, wherein the head component further includes a recessed area that is configured to receive and maintain the feedback mechanism in a position relative to the sensing surface and head component.

8. The tactile feedback device of claim 1, wherein the receiving component is coupled to the feedback mechanism, and wherein the receiving component comprises a compliant member having a head component and a base component, wherein the compliant member facilitates flexing of the receiving component.

9. The tactile feedback device of claim 8, wherein the base component is inseparably coupled to the head component through a neck that flexes in response to said force input.

10. The tactile feedback device of claim 9, wherein the neck extends from the head component into the hollow area and centers the base component in relation to the head component and positions the base component slightly above the hollow area.

11. The tactile feedback device of claim 9, wherein the neck comprises an aperture configured to support the feedback mechanism and to facilitate the operation of the feedback mechanism when the force is applied to the head component.

12. The tactile feedback device of claim 11 wherein the base component further comprises a bottom surface that is configured to relate to the sensing surface and that locates the tactile feedback device above the sensing surface.

13. The tactile feedback device of claim 12, wherein the base component is attached to the sensing surface with an adhesive material.

14. The tactile feedback device of claim 12, wherein the base component is attached to the sensing surface with a fastener.

15. The tactile feedback device of claim 11, wherein the feedback mechanism is configured as a separate component substantially the same size as the aperture and configured to produce a tactile sensation when the neck flexes.

16. An input system comprising:
a touch-based input device comprising a sensing element having a sensing surface, wherein the sensing element is configured to receive and register a force input from a user, and to output a signal to determine the location of the applied force; and
a tactile feedback device comprising a receiving component and a feedback mechanism, said tactile feedback device operates to provide said force input and tactile feedback to said user.

17. The input system of claim 16, further comprising a screen to visually illustrate a result of the applied force about the tactile feedback device.

18. The input system of claim 16, wherein the output signal is sent to a signal processor for determining a location and/or a magnitude of said force input about said sensing element.

19. A method for receiving tactile feedback from a tactile feedback device comprising:
providing a tactile feedback device operable with a force-based input device comprising
a receiving component to receive a force input from a user that is operable to displace and transfer the received force to a sensing surface of said force-based input device, and
a feedback mechanism to provide tactile feedback to the user to ensure proper and complete force transfer and registration;
applying a force to the receiving component; and
receiving tactile feedback from the feedback mechanism.

20. The method of claim 19, further comprising causing the receiving component, configured as a compliant member, to bend in response to said force input.

21. The method of claim 19, further comprising causing the receiving component, configured as a pivoting member, to pivot in response to said force input.
